(19) United States
(12) Patent Application Publication
(10) Pub. No.: US 2023/0237601 A1
(43) Pub. Date: Jul. 27, 2023

(54) METHODS AND SYSTEMS FOR PURCHASING AND COMMERCIALIZING REAL ESTATE

(71) Applicant: Prescott Paulin, Decatur, IL (US)

(72) Inventor: Prescott Paulin, Decatur, IL (US)

(21) Appl. No.: 18/102,019

(22) Filed: Jan. 26, 2023

Related U.S. Application Data
(60) Provisional application No. 63/303,331, filed on Jan. 26, 2022.

(51) Int. Cl. G06Q 50/16; G06Q 30/0601

(52) U.S. Cl. CPC G06Q 50/167; G06Q 30/0611; G06Q 30/0613; G06Q 2220/00

(57) ABSTRACT

Embodiments of the present disclosure may include a computer implemented method of purchasing and commercializing real estate, including establishing a geospatial database of fractionalized real estate properties. Embodiments may also include enabling a buyer and a seller to input into a further database data corresponding to the buyer's and seller's desired parameters for purchase or rent of a portion of a fractionalized real estate property. Embodiments may also include automatically obtaining and storing data corresponding to information relating to the buyer and seller. Embodiments may also include matching a buyer and a seller for a transaction relating to a portion of a respective fractionalized real estate property. Embodiments may also include facilitating communication between the buyer and seller for negotiation of an agreement for purchase or rent of the portion of fractionalized real estate property.

### BACKGROUND OF THE INVENTION

### 1. Field of the Invention

The present application is a U.S. patent application which claims benefit of priority from U.S. Provisional Patent Application 63/303,331, filed Jan. 26, 2022, the entirety of which is incorporated herein by reference.

### DESCRIPTION OF RELATED ART

There have been previous methods and systems developed that relate to purchasing and commercializing real property, i.e., real estate and commercial property. However, these systems and methods are time-consuming and are difficult to generate income therefrom. Commissions or fees charged by third party facilitators are often imposed.

Further, in regards to real estate used for tradeshow or similar purposes, in the past, tradeshow space has required move in and move out of all items in a booth or designated space at specific times, thereby limiting the available marketing and advertising time of the tradeshow space. Still further, large corporations typically purchase the entire real estate property and rent the real estate to one organization for a conference; such organization is then responsible for dividing up the entire real estate into smaller parcels or portions for participants or users to rent. This segmenting is time-consuming and forces unnecessary fees to participants or users for rental or purchase of the smaller parcels.

Therefore, what is desired are exemplary methods and systems that improve accessibility for the ownership and widespread utility of larger parcels of real estate to be managed beyond large corporations, and that eliminate the time consuming and costly efforts of segmenting the real estate into smaller parcels or portions. Additionally, the exemplary methods and systems eliminate middlemen and their associated costs, while increasing the available time for utilization of smaller real estate parcels or portions.

### BRIEF DESCRIPTIONS OF THE DRAWINGS

These and/or other aspects of the present general inventive concept will become apparent and more readily appreciated from the following description of the exemplary arrangements, taken in conjunction with the accompanying drawings of which:

FIG. 1 is a schematic diagram of an exemplary system for purchasing and commercializing real estate;

FIG. 2 is a schematic diagram of an alternative exemplary system and method for purchasing and commercializing real estate utilizing a decentralized autonomous organization;

FIG. 3 is a schematic diagram of an alternative exemplary system and method for purchasing and commercializing real estate;

FIG. 4 is a exemplary arrangement of an exemplary remote electronic device;

FIG. 5 is a partial alternative exemplary process flow of an alternative exemplary method for purchasing and commercializing real estate;

FIG. 6 is a partial alternative exemplary process flow of an alternative exemplary method for purchasing and commercializing virtual real estate;

FIG. 7 is a schematic diagram of an alternative exemplary system for purchasing and commercializing real estate;

FIG. 8 is an exemplary process flow of an alternative exemplary method for purchasing and commercializing real estate;

FIG. 9 is a continuation of the exemplary process flow of the alternative exemplary method of FIG. 8;

FIG. 10 is a continuation of the exemplary process flow of the alternative exemplary method of FIGS. 9-10;

FIG. 11 is an exemplary process flow of an alternative exemplary method for purchasing and commercializing real estate; and

FIG. 12 is a continuation of the exemplary process flow of the alternative exemplary method of FIG. 11.

### DESCRIPTION OF INVENTION

Reference will now be made in detail to the exemplary arrangements of the present general inventive concept, examples of which are illustrated in the accompanying drawings, wherein like reference numerals refer to the like elements throughout. The exemplary arrangements are described below in order to explain the present general inventive concept by referring to the figures.

The present general inventive concept relates to methods and systems for purchasing real estate. The exemplary arrangements further relate to methods and systems for dividing or fractionalizing the purchased real estate into a plurality of parcels for purchase or rent. Still further, the exemplary arrangements relate to methods and systems for crowdfunding or crowdsourcing or establishing a decentralized autonomous organization (“DAO”) to facilitate the purchase and commercialization of the real estate.

Embodiments of the present disclosure may include a computer implemented method of purchasing and commercializing real estate, including establishing a geospatial database of fractionalized real estate properties. Embodiments may also include enabling a buyer and a seller to input into a further database data corresponding to the buyer's and seller's desired parameters for purchase or rent of a portion or parcel of a fractionalized real estate property.

Embodiments may also include automatically obtaining and storing data corresponding to information relating to the buyer and seller. Embodiments may also include matching a buyer and a seller for a transaction relating to a portion of a respective fractionalized real estate property. Embodiments may also include facilitating communication between the buyer and seller for negotiation of an agreement for purchase or rent of the portion of fractionalized real estate property. Embodiments may also include enabling third party payment entities to complete payment according to the agreement. Embodiments may also include enabling the buyer and seller to communicate regarding the buyer's access to the portion of fractionalized real estate.

In some embodiments, the agreement may include a smart contract formed between the buyer and seller. In some embodiments, the smart contract may be stored on a blockchain database or network. In some embodiments, the buyer may be enabled to store the buyer's personal property at the portion of fractionalized real estate. In some embodiments, the method may further include enabling risk mitigation. In some embodiments, digital assets may be committed as collateral to guarantee the safety of the buyer's property stored at the portion of fractionalized real estate.

### Distributed Ledger

A distributed ledger is a decentralized database system that enables multiple entities to access and synchronize a shared database across various sites, institutions, or geographical locations. The distributed nature of the ledger allows for public “witnesses” to verify the authenticity of transactions, eliminating the need for a central authority to oversee and validate the transactions.

Each participant in the network, referred to as a node, has access to the recordings shared on the network and maintains an identical copy of the ledger. Any updates or additions made to the ledger are reflected and replicated to all participants in real-time, ensuring a consistent and accurate record of all transactions. In contrast, centralized ledgers, commonly used by companies, are more vulnerable to cyber-attacks and fraud as they have a single point of failure.

Distributed ledger technology (“DLT”) can take on various forms, including permissioned or permissionless systems, depending on whether anyone or only approved participants can run a node to validate transactions. Additionally, different consensus algorithms can be used, such as proof of work, proof of stake, voting systems, and hashgraph. Some DLT systems may also be mineable, where new coins can be claimed through the use of a node, while others may not be mineable, with the creator of the cryptocurrency owning all the coins at the onset. Blockchain technology is one form of DLT, but there are also other forms of distributed ledger technology that do not utilize blockchain.

### Blockchain

A blockchain is a decentralized digital ledger that uses cryptography to secure and link a growing list of records, known as blocks. Each block contains a cryptographic hash of the previous block, a timestamp, and transaction data, usually represented in the form of a Merkle tree. The timestamp proves that the transaction data existed when the block was published, and it is included in the cryptographic hash. As each block contains information about the previous block, they form a chain, with each additional block reinforcing the previous ones. This makes blockchains resistant to the modification of their data, as once recorded, the data in any given block cannot be altered retroactively without altering all subsequent blocks.

Blockchains are typically managed by a peer-to-peer network, used as a publicly distributed ledger, where nodes collectively adhere to a protocol to communicate and validate new blocks. Although blockchains are not completely unalterable, as forks are possible, they are considered secure by design and exemplify a distributed computing system with high Byzantine fault tolerance.

A blockchain is composed of several layers, including infrastructure (hardware), networking (node discovery, information propagation and verification), consensus (proof of work, proof of stake), data (blocks, transactions), and application (smart contracts/decentralized applications, if applicable).

Blocks hold batches of valid transactions that are hashed and encoded into a Merkle tree. Each block includes the cryptographic hash of the prior block in the blockchain, linking the two. The linked blocks form a chain, with each new block confirming the integrity of the previous one, all the way back to the initial block, known as the genesis block. To assure the integrity of a block and the data contained in it, the block is usually digitally signed.

### NFT

NFT, or non-fungible token, is a unique digital asset that represents ownership of a unique item or piece of content, such as a digital artwork, collectible, music, or video. Unlike traditional digital assets, such as a jpeg of a painting, an NFT is verified on a blockchain, which is a decentralized, digital ledger that records transactions across a network of computers. This verification ensures that the NFT is truly one-of-a-kind and cannot be replicated or replaced by another identical copy.

The use of blockchain technology in NFTs also allows for the tracking of ownership and provenance of the asset. This means that the entire history of the NFT, including all past transactions, can be easily traced and verified. This feature is particularly valuable for digital art and collectibles, as it provides a way for artists and creators to monetize their work and for buyers to ensure the authenticity and uniqueness of their purchases.

NFTs are also highly divisible, meaning that the ownership of an NFT can be split among multiple parties or can be resold on different platforms. This flexibility allows for a new marketplace to be created for unique digital assets and opens new opportunities for artists and creators to monetize their work.

### Smart Contracts

Smart contracts are digital agreements that are designed to facilitate, verify, or enforce the negotiation or performance of legal obligations. They use computer protocols to automate the execution of the contract and allow for credible transactions to take place without the need for third parties. The concept of smart contracts was first coined by computer scientist Nick Szabo in 1996.

A smart contract is a set of promises, specified in digital form, that includes protocols for the parties to perform on those promises. They can be implemented using blockchain technology, though this is not a necessary requirement. Some recent interpretations of smart contracts are used more specifically to refer to general-purpose computation that takes place on a blockchain or distributed ledger. In this context, smart contracts are not limited to the traditional concept of a contract and can be any type of computer program.

The use of Byzantine fault tolerant algorithms and programming languages with varying degrees of Turing-completeness allows for the creation of custom and sophisticated logic in smart contracts. Cryptocurrency protocols like Bitcoin and Ethereum are notable examples of smart contracts that use decentralized security, encryption, and limited trusted parties that fit Szabo's definition of a digital agreement with observability, verifiability, privity, and enforceability.

Smart contracts have several advantages over traditional financial instruments, such as reducing counterparty risk, shortening settlement times, and increasing transparency. Some financial institutions have proposed the use of smart contracts for “smart bonds” that use the Bitcoin blockchain to automate payment streams, creating a self-paying instrument.

### Tokenization

Tokenization is the process of converting assets, rights, or other tangible or intangible assets into a digital token that can be stored and tracked on a blockchain, a decentralized digital ledger. This digital token can represent ownership of a specific asset, such as a piece of art, real estate, or a stock in a company. Tokenization allows for the digitization of assets and facilitates the buying, selling, and trading of those assets in a more efficient and secure manner.

Tokenization is a process that allows for the conversion of assets, rights, or other tangible or intangible assets into a digital token that can be stored and tracked on a blockchain. This digital token can represent ownership of a specific asset, such as a piece of art, real estate, or a stock in a company. Tokenization allows for the digitization of assets and facilitates the buying, selling, and trading of those assets in a more efficient and secure manner.

One of the key benefits of tokenization is the ability to fractionalize assets. This means that instead of needing to purchase an entire asset, such as a building or a piece of art, tokenization allows for the ability to purchase a smaller portion or token of that asset. This allows for more people to invest in and own a piece of that asset, increasing accessibility for investors with smaller budgets.

Another benefit of tokenization is the ability to automate and streamline the process of buying, selling, and trading assets. Because tokenization is facilitated by blockchain technology, the process of buying and selling assets can be done in a more secure, transparent, and efficient manner. Smart contracts, which are self-executing contracts with the terms of the agreement written directly into lines of code, can also be used to automate the process of buying, selling and trading tokenized assets.

Tokenization also increases the potential for global investment, as digital assets can be easily traded on digital platforms without the need for physical possession of the assets. This can open up new opportunities for investors and businesses, as they can access a global market of buyers and sellers. In the case of real estate, tokenization allows for the fractionalization of ownership, making it possible for many investors to own a piece of a property.

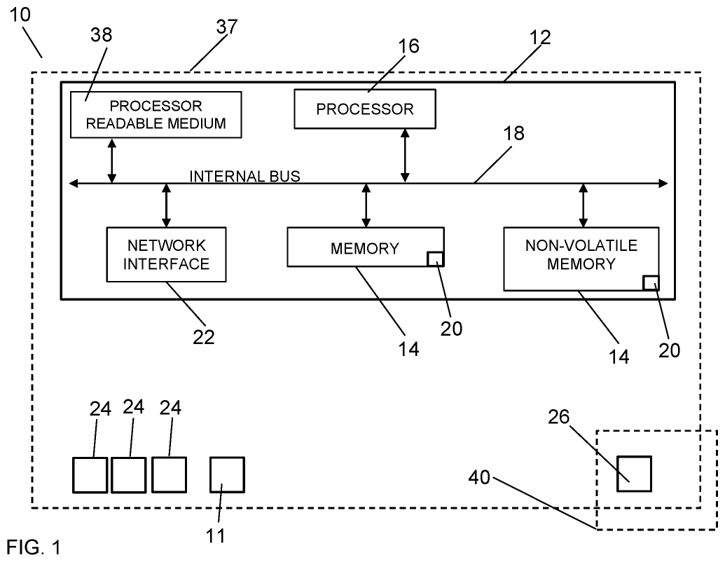

Referring to FIGS. 1, the real estate purchasing and commercialization system, designated generally as 10, is illustrated. In an exemplary arrangement of the exemplary system 10, the system 10 comprise a computer implemented system for fractionalizing and commercializing real estate, including a distributed ledger. The exemplary distributed ledger stores parameters for a decentralized autonomous organization. The exemplary parameters include instructions for purchase of real estate. The exemplary decentralized autonomous organization (“DAO”) is configured to cause purchase of real estate according to the parameters, division of the real estate into fractional shares, and minting of at least one non-fungible token for each of the fractional shares. In exemplary arrangements, each of the non-fungible tokens is stored by the distributed ledger, is configured to be purchased, and each includes at least one smart contract embedded therein, wherein the smart contract includes usage parameters, wherein the usage parameters define rights with respect to the fractional share of real estate transferred to a purchaser of the non-fungible token. However, the exemplary arrangements are not limited hereto.

In exemplary arrangements, in general, the exemplary system 10 is operative responsive to processor executable instructions on a processor readable medium to establish a DAO for the purchase of real estate, and more particularly, real estate intended to be divided into a grid of smaller parcels or portions for commercialization. The exemplary DAO is a member-owned community without centralized leadership. The exemplary DAO enables collaboration with internet users and creates a safe and secure method of committing various members' funds to a specific cause, for example, the purchase of real estate. The exemplary DAO includes a DAO financial account including funds that no one member can use without the approval of the group. Of course, these arrangements are merely exemplary, and in other embodiments, other arrangements may be used.

In exemplary arrangements, the DAO's decisions are governed by proposals and voting by the members to ensure every member of the DAO has a voice. The DAO is managed by a smart contract, which is computer code deployed on a decentralized or distributed block chain network or system, and which runs as programmed. In exemplary arrangements, a system manager 11 is operative to utilize the central computer 12 to deploy the DAO smart contract computer code on a decentralized or distributed blockchain network or system. However, the DAO smart contract may be managed and enforced by other databases or systems. In exemplary arrangements, the exemplary system manager 11 comprises at least one of a human being, a group of individuals with a common intent, an entity, corporation, or another computer or system. In exemplary arrangements, once the DAO smart contract has been deployed, users of the system 10 thereafter become members of the DAO through purchase of a membership share embodied in a non-fungible token (“NFT”). Alternatively, the DAO members may agree to be members prior to the deployment of the DAO smart contract, and also agree to the rules embodied in the DAO smart contract computer code, before it is deployed. However, as can be appreciated, these arrangements are merely exemplary, and in other embodiments, other arrangements may be used.

The DAO smart contract is similar to an operating agreement and/or bylaws. In essence, the DAO's smart contract defines the rules of the DAO and holds the group's financial account. Once the contract becomes live on a decentralized or distributed blockchain system, for example, Ethereum, no one member or other person can change the rules of the smart contract, except by vote. If anyone tries to do something that is not covered by the rules and logic in the computer code of the smart contract, it will fail. The DAO financial account including the funds is defined by the smart contract as well, so that no one member or other person can spend the money in the DAO account without DAO member approval. However, this arrangement is merely exemplary, and other arrangements may be used.

In exemplary arrangements, in general, the DAO is operative responsive to computer code embodied in the DAO smart contract to purchase real estate with the funds in the DAO account. The DAO may utilize smart contract oracles to access external information resources, databases, or systems such as real estate purchasing platforms available on the internet to determine acceptable real estate properties for purchase with the DAO funds. The members of the DAO agree to the purchase of the real estate from a plurality of real estate properties determined by the DAO smart contract as meeting real estate criterion set by the members of the DAO. In alternative exemplary arrangements, the real estate may be purchased by other organizations, entities, or natural persons. In such arrangements, the DAO may be foregone.

In exemplary arrangements, the exemplary real estate purchasable by the system 10 comprises any type of real estate, including any real property or real estate zoned in any manner. As used herein, the term real estate includes, but is not limited to, real estate for trade shows, real estate for hotels or motels, real estate for resorts, real estate for expos or expositions, real estate for swap meets, real estate for condos, real estate for farmers markets, real estate for conferences, real estate for office space, real estate for sporting events, private real estate, commercial real estate, real estate for warehouse or storage purposes, real estate for gun ranges, or real estate used for any other lodging or business purposes.

In exemplary arrangements of the system 10, responsive to processor executable instructions on a processor readable medium, or responsive to computer code in the DAO smart contract, the system 10 or the DAO smart contract is operative to divide or section the DAO purchased real estate into smaller parcels that can be purchased, rented, or sold. The DAO account is funded through the purchase of parcel non-fungible tokens by DAO members. Each parcel NFT corresponds to a respective parcel that is part of the grid determined by the exemplary system 10 or the smart contract. As can be appreciated, this arrangement is merely exemplary, and other arrangements may be used.

In exemplary arrangements, through purchase of a parcel NFT by a DAO member, the purchasing DAO member acquires a fractional interest in and responsibility for the real estate. For example, a fractional responsibility for maintaining and paying costs on the parcel (portion of the DAO purchased real estate) corresponding to the DAO member's purchased NFT. Additionally, through purchase of a parcel NFT, the DAO member also acquires the right to use the parcel as desired, as well as the right to commercialize the parcel to generate income. However, in exemplary arrangements, the DAO member is required to pay maintenance fees for the parcel associated with the NFT. Such maintenance fees include utility costs, mortgage fees, insurance fees, and/or any other fees generally associated with owning commercial or private real estate. The DAO enables these costs to be split across numerous members, thereby decreasing the magnitude of costs imposed on each member. However, as can be appreciated, this arrangement is merely exemplary, and other arrangements may be used.

The exemplary real estate purchasing and commercialization system 10 includes a central computer 12. The central computer 12 includes a data store or nonvolatile memory 14, a processor 16, and at least one circuit 18. The system 10 further includes a software application 20 that includes a user interface 22 that is configured to enable users of the system 10 to make inputs to the system 10 and to receive outputs from the system 10. In exemplary arrangements, the software application 20 is operatively available through access to the internet and is embodied on a website associated with the system 10. In alternative exemplary arrangements, the software application 20 comprises processor executable instructions that are downloadable to a data store or processor readable medium of an electronic device of a user of the system 10. For example, a smart phone or computer app like those available on Apple's® or Android's® app store. Of course, this arrangement is exemplary, and in other embodiments, other arrangements may be used.

In exemplary arrangements, the real estate purchasing and commercialization system 10 further includes a plurality of electronic devices 24, at least one node 26, and at least one telecommunications network 37. The central computer 12, the plurality of electronic devices 24, and the at least one node 26 are configured to communicate wirelessly through the telecommunications network 37. In exemplary arrangements, the plurality of electronic devices 24 include smart phones, laptop computers, tablets, Ipads®, desktop computers, GPUs (graphics processing units), ASIC (application specific integrated circuits), or any other type of electronic device including at least one circuit. As can be appreciated, these arrangements are merely exemplary, and in other embodiments, other arrangements may be used.

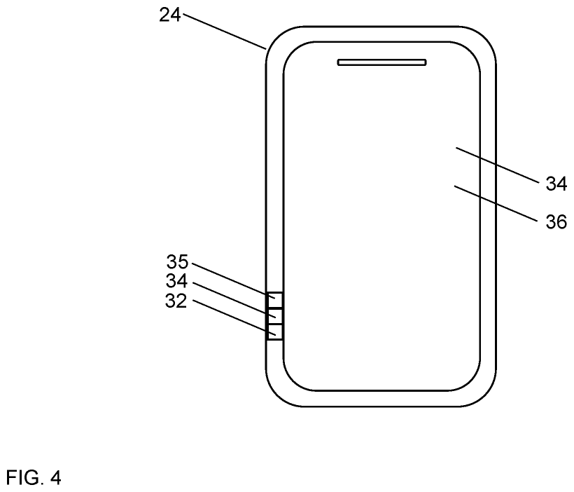

Generally, as shown in FIG. 4, each of the plurality of electronic devices 24 includes a screen or output device 30, a data store 32 that includes a processor a readable medium, at least one circuit 34, and an input device 36. In exemplary arrangements, the exemplary electronic devices enable a system user or a member of the DAO to access the software 20 or a website associated with the system 10 for purchase, trading, or renting of the NFTs. However, these arrangements are merely exemplary, and in other embodiments, other arrangements may be used.

In exemplary arrangements, the real estate purchasing and commercialization system 10 includes processor executable instructions embodied on at least one processor readable medium 38. The exemplary processor executable instructions embodied on the processor readable medium 38 are operative to cause the central computer 12, the electronic devices 24, the node 26, and/or the blockchain system 40 to perform the operations, methods, functions, and method steps discussed herein. In exemplary arrangements, the processor readable medium 38 is included in or operatively connected to the central computer 12, each of the plurality of electronic devices 24, and to each respective node 26. The processor executable instructions are configured to perform the functions of a blockchain system or decentralized or distributed ledger system 40. Of course, this arrangement is merely exemplary, and in other embodiments, other arrangements may be used.

In exemplary arrangements, the processor executable instructions are operative to cause, when executed, the exemplary system 10 to make or mint the parcel NFTs 42 and caused them to be made available for purchase by DAO members or others. The parcel NFTs are associated with a respective parcel included in the grid of parcels established after the exemplary system 10 has sectioned or fractionalized the DAO purchased real estate into a tract of parcels. In alternative exemplary arrangements the system 10 is configured to fractionalize into parcels or portions other real estate included in the database of the system 10. As can be appreciated, this arrangement is exemplary, and in other embodiments, other arrangements may be used.

In alternative exemplary arrangements, the exemplary processor readable medium 38 includes processor executable instructions that cause the system 10 to deploy the parcel NFTs 42 onto a pre-existing blockchain or decentralized or distributed ledger system. For example, the exemplary system 10 is caused by execution of the processor instructions to deploy the parcel NFTs 42 onto the Ethereum blockchain platform. However, this arrangement is merely exemplary, and in other arrangements, other blockchain or decentralized or distributed ledger platforms may be used.

In exemplary arrangements, after the DAO has purchased the real estate, the exemplary system 10 is operative responsive to processor executable instructions embodied on the processor readable medium to divide the square footage of the purchased real estate into a grid of numerous parcels. For example, the square footage of the purchased real estate is divided into 10′×10′ parcels. However, the exemplary system 10 or DAO smart contract may divide the real estate into parcels of other sizes and arrangements as well. The exemplary system 10 is operative responsive to processor executable instructions to determine a number of available calendar days out of a 365-day year in which the parcels are available to be rented or used. For example, in certain exemplary arrangements in which the real estate is being used for trade show or similar purposes, accounting for weekends, holidays, and other typical nonwork days, the parcels are available for rent for approximately 300 days out of a 365-day calendar year. Further, in such exemplary arrangements in which the real estate is used for tradeshow or similar purposes, the exemplary system 10 is operative responsive to processor executable instructions to determine a plurality of timeslots for each day that the parcel is available for rent. For example, the parcel is available at six different time slots per day, with each timeslot spanning two hours. In alternative exemplary arrangements, the timeslots for each day that the parcel is available for rent may comprise a morning session and an afternoon session. However, the time slot configuration may be used for any other type of real estate as well. Of course, these arrangements are merely exemplary, and in other embodiments, other arrangements maybe used.

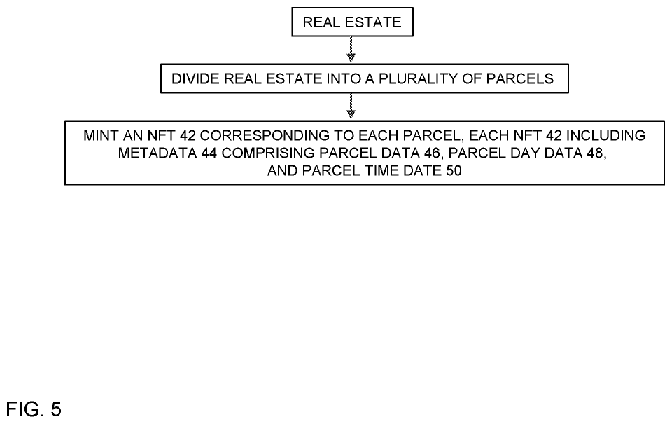

In exemplary arrangements, as shown in FIG. 5, each of the parcel NFTs 42 have metadata associated therewith. The NFT metadata 44 is stored on the blockchain system 40 in association with the corresponding NFT 42. The NFT metadata 44 may include ownership information such as public keys or addresses associated with the NFT. The NFT metadata 44 includes data corresponding to a parcel data 46, a day data 48, and a time data 50. In exemplary arrangements, the parcel data 46 comprises a digital representation of an actual portion of floor space of the DAO purchased real estate. In exemplary methods, the DAO member or owner of a parcel NFT 42 purchases the NFT 42 from the system 10. For example, the DAO member exchanges fiat currency or a type of cryptocurrency for purchase of the NFT 42. The purchase of the NFT 42 is recorded in the block chain system 40 (distributed ledger) of system 10. Thereafter, the owner of the NFT 42 is enabled to use the parcel 46 associated with the NFT 42 as desired. However, as can be appreciated, these arrangements are merely exemplary, and in other embodiments, other arrangements may be used.

In exemplary arrangements, the exemplary system 10 is operative responsive to processor executable instructions embodied on the processor readable medium to enable the DAO member or owner of the parcel NFT 42 to trade the NFT 42 as a complete unit to another potential system user. For example, if the DAO member of the NFT 42 is no longer interested in the parcel data 46, the DAO member is enabled to trade the NFT 42 to another individual, and to receive an amount of fiat currency or some type of cryptocurrency in exchange thereof. The transfer of the NFT 42 from its current owner to its new owner is recorded in the blockchain system 40 along with new metadata 44 corresponding to the new owner. The new owner of the NFT 42 becomes a member of the DAO and takes on the fractional real estate responsibility that the original DAO owner of the NFT acquired. Additionally, the new owner of the NFT 42 acquires all the ownership rights of the original NFT 42 owner, and therefore acquires the rights to commercialize the NFT 42 to generate income.

In alternative exemplary arrangements, the exemplary system 10 is operative responsive to processor executable instructions on the processor readable medium to enable the DAO member to trade or rent all or a portion of the parcel NFT 42 to another individual or entity via a smart contract. For purposes herein, a smart contract is a digital contract that exists on a decentralized, distributed blockchain network, and in which the terms of agreement between the parties to the smart contract is set in computer code. Further, smart contracts can hold digital assets like NFTs within them, or alternatively the smart contracts can be embedded within the NFT. The digital assets of the smart contract can be distributed upon execution when a set of conditions are met based on the computer code defined in the smart contract. Smart contracts often utilize blockchain oracles to trigger actions of the smart contract. A blockchain oracle is a trusted third-party service that provides smart contracts with authenticated external sources of data from the real world through an application programming interface (“API”). As such, oracles connect smart contracts with events external to the blockchain system.

In exemplary arrangements, the exemplary parcel NFTs 42 are configured to include smart contracts embedded therein. The exemplary smart contracts are operative to divide up the rights to use the parcels 46 on specific days 48 and at specific times 50. For example, a DAO member has purchased an exemplary parcel NFT 42 with an intent to generate income from renting out the parcel 46 associated with the NFT 42. In such situations, the DAO member establishes smart contracts that are embedded within the NFT 42 defining agreement terms and conditions for usage of the parcel 46. For example, a smart contract embedded within the NFT 42 is an agreement for usage of the parcel 46 based on a specific day 48 and at a specific time 50. Further, the DAO member who owns the parcel NFT 42 may disperse the maintenance costs associated with the NFT 42 between the various smart contracts. Of course, as can be appreciated, this arrangement is merely exemplary, and in other embodiments, other arrangements may be used.

As an exemplary Scenario 1 in which the real estate is intended to be used for trade show or similar purposes, a technology tradeshow is taking place at a conference center (or real estate) owned by the DAO. The conference center includes a grid of parcels 46, and each parcel 46 is associated with a DAO member's parcel NFT 42. The technology tradeshow takes place over multiple days, and each day includes multiple timeslots available to be purchased by interested tradeshow participants. In exemplary arrangements, the owner of the NFT 42 establishes smart contracts for each of the timeslots on each day of the technology conference. Thereafter, the tradeshow participants are enabled to access the system 10 software via their respective remote electronic device 44 and agree to the terms and conditions of the smart contract for timeslots and days of the technology conference. The user's agreement to the terms and conditions of the contract, along with a deposit of the required payment to system 10 or smart contract, enables the user to acquire the rights to the parcel 46 for the days and times selected.

In exemplary arrangements, Scenario 1 can be applied to any other type of real estate as well. For example, the methods steps and systems can be used for scheduling hotel rooms or office space at different times of the day, whole days, or a user desired duration of time. It should be understood that the method steps and systems discussed in connection with Scenario 1 maybe applied to any other type of real estate.

In exemplary arrangements, the participant may agree to the terms of the smart contract for multiple timeslots on multiple days, or a single timeslot on a specific day, or any combination thereof. As such, the exemplary system 10 enables the NFT owners and potential parcel users or renters to quickly and easily autonomously sell and schedule parcel or floor space, without the need for third parties.

In exemplary arrangements, the system 10 is operative responsive to processor executable instructions on the processor readable medium to display on the software application 20 a virtual real time map of the various parcels 46 in the grid of parcels at the DAO purchased real estate. The virtual map displays the various parcels 46 that have already been rented or scheduled for use. The virtual map shows the days and times for which the parcels 46 have been rented or scheduled. Interested potential parcel users or renters can view the virtual map of the various parcels 46 at the DAO purchased real estate and determine which parcel 46, and at which day 48 and times 50 is best suited for optimizing marketing and advertising of the interested potential user's or renter's business, products, or services, or for leisure purposes in arrangements in which the purchased real estate is a hotel, resort, or lodge. Once an interested potential parcel user or renter has decided upon a parcel 46, day 48, and time 50, the interested potential parcel user or renter is enabled to select a smart contract corresponding to the user decided upon parcel 46, and at the specific day 48 and time 50. The interested potential parcel user or renter is enabled to select the desired smart contract through the user interface 22 of the software application 20 by at least one input to the user's respective electronic device 24. However, as can be appreciated, these arrangements are merely exemplary, and in other embodiments, other arrangements may be used.

In alternative exemplary arrangements, partial ownership of the parcels 46 may be established through time slot NFTs 43 generated by the system 10 responsive to processor executable instructions embodied on the processor readable medium. In such exemplary arrangements, the exemplary system 10 is operative to segment the individual parcels 46 into timeslots corresponding to a specific time or specific day and can be done for the entire availability period of the calendar year. In such exemplary arrangements, each timeslot NFT 43 corresponds to a specific timeslot or partial ownership of the parcel 46 associated with the NFT 43. As such, this alternative exemplary arrangement enables the DAO members to purchase NFTs for all timeslots at a particular parcel 46 or purchase multiple different timeslot NFTs corresponding to various timeslots at various parcels 46. The DAO members can then sell the individual timeslots NFTs, or the DAO members can rent the timeslot NFTs through smart contracts, and never confer complete ownership of the parcel 46 to another individual. It should be understood that timeslots may represent 10 minutes, 30 minutes, 1-hour, multiple hours, multiple days, or multiple months. Alternatively, a system user may purchase multiple NFTs to string together a duration of time. However, as can be appreciated, this arrangement is merely exemplary, and in other embodiments, other arrangements may be used.

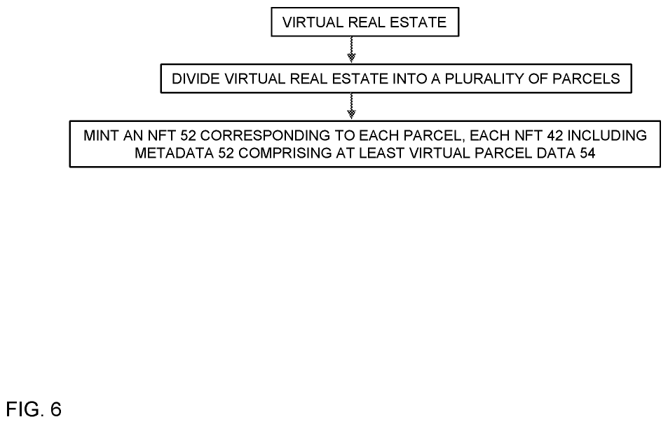

In alternative exemplary arrangements, as shown in part in FIG. 6, the exemplary system 10 also provides for the purchase of metaverse real estate. The metaverse is a network of 3-D virtual worlds focused on social connection. Metaverse real estate is virtual plots of land. Each virtual plot of land is represented by an NFT. In alternative exemplary arrangements, the system 10 is operative responsive to processor executable instructions to enable the purchase of virtual real estate from platforms such as the Super World Virtual Real Estate platform. Alternatively, the system 10 may include its own metaverse real estate purchasing platform.

In alternative exemplary arrangements in which system 10 is operative responsive to processor executable instructions on the processor readable medium to provide for purchase of metaverse real estate, each NFT 42 for a real-world parcel 46 has a corresponding metaverse NFT 52. The corresponding metaverse NFT 52 is identical to the NFT 42, except that a virtual parcel 54, identical to the parcel 46, is associated therewith. The metaverse NFT 52 may be traded or sold in an identical manner as the NFT 42, and partial rights to the virtual parcel 54 associated with the NFT 52 may be transferred via smart contracts in the identical manner as NFT 42.

In alternative exemplary arrangements of the system 10 that is operative to provide for purchase of real estate in the metaverse, the DAO member who purchases the NFT 42 may also purchase the NFT 52 that is associated with the virtual parcel 54. If the DAO member purchases both the real world NFT 42 and the metaverse NFT 52, the DAO member is enabled to hold or commercialize either NFT in the methods discussed herein. Similar to the NFT 42, the metaverse NFT 52 may include maintenance fees associated therewith. For example, the metaverse NFT 52 may include server or database fees associated therewith to maintain the metaverse real estate. In alternative exemplary arrangements, the DAO owner is permitted to purchase only one of the NFT 42 or NFT 52, and not purchase the other. In still other alternative exemplary arrangements, a separate DAO may be established for the purchase of the metaverse real estate. The exemplary metaverse DAO is identical to and operates in a similar manner to the real-world DAO. Of course, this arrangement is merely exemplary, and in other embodiments, other arrangements may be used.

In alternative exemplary arrangements of the system 10 that is operative to provide for the purchase of real estate in the metaverse, the metaverse NFTs 52 include metaverse metadata 53. The exemplary metadata 53 is stored on the blockchain system 40 in association with the corresponding NFT 52. The exemplary metadata 53 may include any information or attraction feature relating to the virtual parcel 54 associated with the respective NFT 52. Further, the exemplary metadata 53 may include any information or attraction features relating to other virtual real estate in the metaverse adjacent to the virtual parcel 54, or in close proximity thereto. For example, the metadata 53 may include data corresponding to information regarding virtual real estate owned by celebrities adjacent to the virtual parcel 54, thereby enabling a premium to be charged for the purchase, rental, or usage rights of the virtual parcel 54 associated with the respective NFT 52. In alternative exemplary arrangements, the metadata 53 associated with a respective NFT 52 may include data corresponding to invitations or other “neighborly rights” for parties or events at virtual real estate adjacent or in close proximity to the virtual parcel 54. The invitation data and an associated date and time for the neighborly event may be advertised in association with the NFT 52 so that a premium can be charged for the purchase, rental, or usage rights of the virtual parcel 54 associated with the respective NFT 52. In such exemplary arrangements, users of the system 10 may trade similarly valued NFTs 52 with the “neighborly rights.” In addition, in such exemplary arrangements, smart contracts may be used to achieve this feature of the system 10. For example, the users can list their NFTs 52 and the associated “neighborly rights” in the metadata 53 and then publicly notify others what type of value they expect in return through a smart contract, like a similarly valuable NFT 52 with “neighborly rights” or a specific amount of fiat or crypto currency. Of course, this alternative arrangement is merely exemplary, and in other embodiments, other arrangements may be used.

In alternative exemplary arrangements, the system 10 may charge a fee either to the DAO owner or the transferee of rights to the parcel 46. The fee may be charged at any time during the trade, sale, or rental of the rights to the parcel 46, or upon the transferee taking actual ownership or occupancy of the parcel 46. However, in exemplary arrangements, fees are not charged by the system 10. Of course, this arrangement is exemplary, and other arrangements may be used.

In alternative exemplary arrangements, the system 10 determines a period of time during which trades of the NFTs and the transferring of rights to the parcels associated with the NFT via smart contracts may take place. For example, the exemplary system 10 may determine a finite time in which trades, sales, or rentals of the NFTs and the rights conferred by smart contracts take place. The exemplary finite time may be two days, for example. However, this arrangement is exemplary, and other arrangements may be used.

In alternative exemplary arrangements, standard layout arrangements are used for each parcel. For example, as part of the maintenance fees imposed upon the DAO member for their specific parcel associated with their purchased NFT, the DAO member is required to maintain a certain standard layout for their parcel. For example, the standard layout includes a table, chairs, a TV or display screen, electrical outlets, fans, a mini fridge, beds, desks, lights, and/or any other fixtures that the DAO as a whole agrees to as the standard layout. This requirement of a standard layout reduces the move in and move out times for a user of the parcel because the user knows how the parcel will look and does not have to furnish the parcel on their own. As the parcel user does not have to furnish the parcel on their own, the marketing and advertising, or leisure or business operations time per parcel is increased. As can be appreciated, this arrangement is exemplary, and other arrangements may be used.

In alternative exemplary arrangements, users who acquire rights to the parcel through a smart contract may further transfer those rights to other potential users via additional smart contracts. Of course, as in typical practice with real world contracts, the DAO member who owns the NFT associated with the parcel that is the subject of the additional smart contract is enabled to optionally approve or disapprove any additional smart contracts beyond the smart contract between the DAO member and the first transferee. In some alternative exemplary arrangements, the NFTs and the rates confirmed by the smart contracts may be traded on other blockchain systems or distributed ledger systems that support such NFTs and smart contracts. As such, a secondary market for partial rights to the parcel is created. Of course, this arrangement is exemplary, and other arrangements may be used.

In alternative exemplary arrangements, the exemplary system 10 may be used to fund and transfer rights to real estate (real world or metaverse real estate) associated with weapons training, gun range training, and/or weapons and ammunitions warehouses, stockpiles, or storage. For example, the exemplary system 10 may be used to fund and transfer ownership rights or usage rights of a gun range, or portions or timeslots thereof. In such alternative exemplary arrangements, in a similar manner as with other types of real estate, the exemplary system 10 may be utilized to establish a DAO for the purchase of the weapons related real estate, associate physical portions of the real estate or timeslots for usage thereof with respective NFTs, and record the ownership, purchases, rentals, and/or transfer of these NFTs between individuals or entities on the blockchain system. In such alternative exemplary arrangements, the NFTs may have metadata associated therewith advertising a certain amount of ammunitions or other weapons related resources or supplies from a stockpile that is also purchased by the DAO to be used by the owner of the NFT or the individual with usage rights thereto. In still other alternative exemplary arrangements, the stockpile of weapons related resources, supplies, ammunitions may be divided among the NFTs, and each respective NFT includes a portion of the stockpile of weapons related resources, supplies, or ammunition for usage during the timeslots or other usage apportionments for each respective NFT. In a similar manner with NFTs corresponding to other types of real estate, physical or virtual, the NFTs corresponding to the weapons related real estate may be traded, sold, rented, or otherwise transferred in whole or in part. Of course, these alternative arrangements are merely exemplary, and in other embodiments, other arrangements may be used.

In alternative exemplary arrangements, the exemplary system 10 may be used to fund and transfer rights to real estate (real world or metaverse real estate) associated with three-dimensional (3D) printing equipment and/or additive manufacturing equipment. For example, the exemplary system 10 may be used to fund and transfer ownership rights or usage rights of a three-dimensional single or multi-material (metals, plastics, etc.) printer, or portions or timeslots thereof. In such alternative exemplary arrangements, in a similar manner as with other types of real estate, the exemplary system 10 may be utilized to establish a DAO for the purchase of the 3D printer related real estate, associate physical portions of the real estate or timeslots for usage thereof with respective NFTs, and record the ownership, purchases, rentals, and/or transfer of these NFTs between individuals or entities on the blockchain system. However, the present general inventive concept is not limited thereto. That is, the exemplary system 10 may also be used to fund and transfer rights to real estate (real world or metaverse real estate) associated with various types of manufacturing processes, including but not limited to additive manufacturing.

The exemplary system 10 may also be used to offset the costs of ownership associated with a separate entity, such as when a government entity purchases the equipment and seeks an arrangement from private industry to contribute funding to maximize the utility of the investment initiated through taxpayer funded resources. In such alternative exemplary arrangements, the NFTs may have metadata associated therewith advertising a certain amount of 3D printing material stock or other material related resources or supplies from a stockpile that is also purchased by the DAO to be used by the owner of the NFT or the individual with usage rights thereto. In still other alternative exemplary arrangements, the stockpile of printing materials related resources, supplies, and/or stocks may be divided among the NFTs, and each respective NFT includes a portion of the stockpile of printing material related resources, supplies, or stocks for usage during the timeslots or other usage apportionments for each respective NFT. In a similar manner with NFTs corresponding to other types of real estate, physical or virtual, the NFTs corresponding to the printing related real estate may be traded, sold, rented, or otherwise transferred in whole or in part. Of course, these alternative arrangements are merely exemplary, and in other embodiments, other arrangements may be used. By way of example, if an NFT owner is seeking to print multiple copies of a part or other printing output configuration, that NFT owner may want to purchase or rent timeslots adjacent to the initial printing job to minimize repetitive setup costs and affiliated labor charges needed to configure the equipment prior to the start of printing.

An alternative exemplary arrangement comprises a system and method of purchasing and commercializing real estate comprising: establishing a geospatial database of property and a system with a user interface and an application programming interface (“API”) to facilitate matching between buyers and sellers for a time limited exchange of the access to and usage of seller owned real estate as well as access to and storage of buyer owned property; allowing buyers and sellers of fractionalized real estate space to register on a website to ascribe their intent and ideal intended deal parameters; collecting personal information and corporate registration of buyers and sellers to satisfy government standards in contracting, as well as banking information; collecting the intent of buyers, including specific requests for the type of items to be stored, weight, dimensions, hazardous or limited shelf life materials, price range, and ideal location; facilitating communication between sellers and buyers to establish an agreement of property usage terms; generating and storing a smart digital contract to commemorate the agreed upon conditions of deal terms between seller and buyer; facilitating payment instructions on a one time and/or recurring basis between seller and buyer to ensure deal terms relating to rental and usage are maintained and that funding transfers between parties as intended for the terms of the agreement take place; facilitating data and communication between sellers and a buyer's authorized associates who seek access to the seller's real estate where buyer has granted permission to enter and access a buyer's property; facilitating the communication of data and information related to a buyer's physical access to and usage of a sellers real estate following seller acceptance of deal terms in order to place, monitor, or retrieve buyer-owner property; and facilitating data and information to authorize platform users and government agencies with court acceptable and enforceable documents and/or agreements related to the details of the transactions between seller and buyer as well as details related to the contents of buyer owned property residing on seller owned real estate.

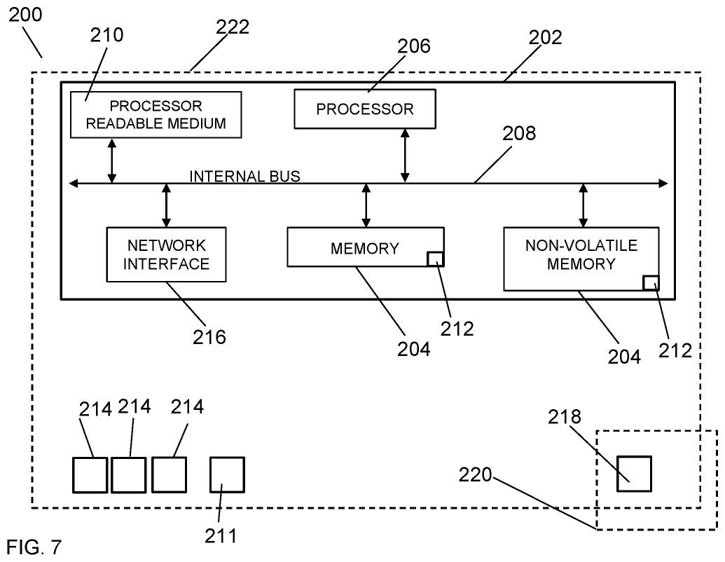

As shown in FIG. 7, alternative exemplary arrangements comprise a system and method 2000 for purchasing and commercializing real estate by enabling sellers to advertise real estate property that has been fractionalized into portions, also referred to herein as parcels, and buyers to purchase or rent the parcels for utilization thereof according to the buyer's personal or business needs. The term buyers and sellers are alternatively referred to herein as users.

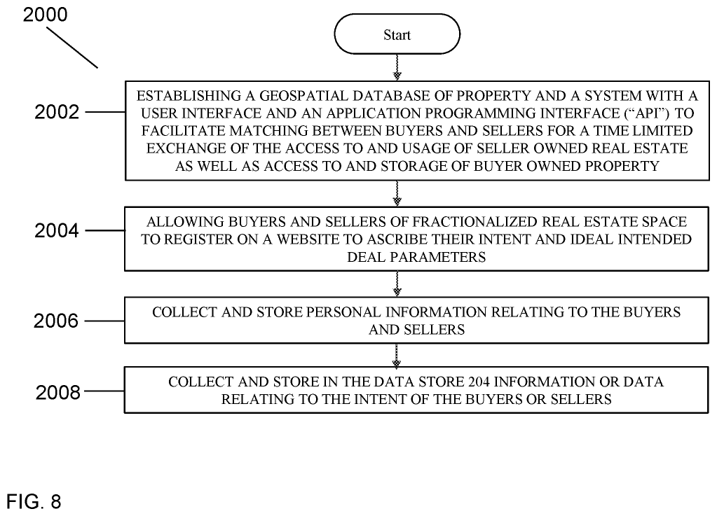

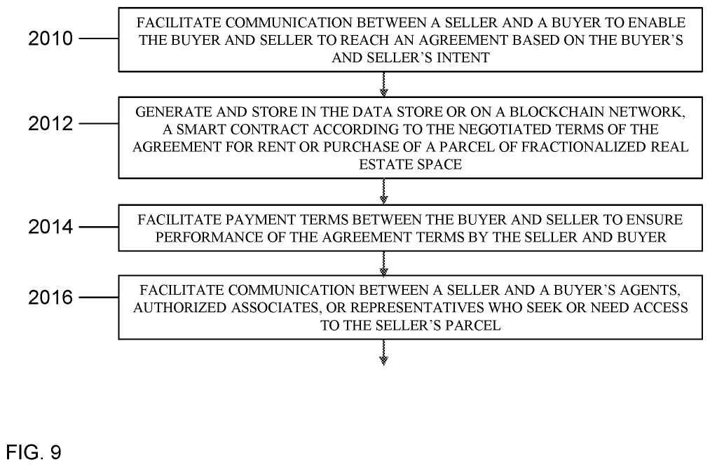

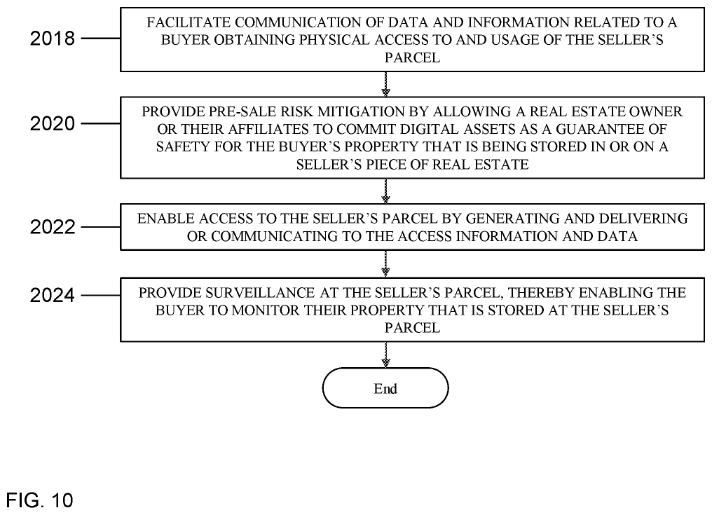

The exemplary method 2000, as shown in FIG. 8-10, comprises a computer implemented method performed by system 200. The exemplary system 200 includes a central computer 202. The exemplary central computer 202 is similar to computer 12 and includes a data store 204, a processor 206, and at least one circuit 208. The exemplary computer 202 is in operative connection with a processor readable medium 210 capable of storing processor readable instructions executable by the processor 206 to perform the various operations, functions, and methods steps of the methods and systems disclosed herein. In alternative exemplary arrangements, the exemplary processor readable medium 210 may alternatively comprise a cloud-based server system that is accessible by a plurality of remote electronic devices.

The exemplary system 200 includes software 212. The exemplary software 212 is stored in whole or in part on the processor readable medium 210. The exemplary software is configured to enable users of the system 200 to make inputs to the system 200 and to receive outputs from the system 200 via remote electronic devices 214 associated with the respective users.

The exemplary remote electronic devices 214 are similar to electronic devices 24 and include an input device such as a button or keyboard, mouse or mouse pad, or a touch screen, an output device such as a display screen or speaker, a memory or data store including a processor readable medium, a processor, and at least one circuit.

The exemplary software 212 includes a user interface 216 that enables the user to interact with the system 200 via the user's respective remote electronic device 214. The exemplary software 212 further includes an API that enables software or systems external to the system 200 to connect with the system 200 and to communicate therewith. The exemplary software 212 is accessible via a website or downloadable from an App Store, such as the app stores previously discussed herein, to the user's remote electronic device 214, as similarly discussed in other arrangements.

The exemplary system 200 further includes at least one node 218. The exemplary node 218 is in operative communication and connection with at least one blockchain network or system 220.

The exemplary system 100 further includes a telecommunications network 222. The exemplary central computer 102, the database 104, the plurality of remote electronic devices 214, the node 218 are configured to communicate through the telecommunications network 222.

In exemplary arrangements, the processor readable instructions executed by the processor 206 of the computer 202 are operative to cause the computer 202, the plurality of remote electronic devices 214, and the node 218 to perform the various operations, functions, and method steps of the methods and systems disclosed herein. That is, the exemplary system 200 is operative to perform the various operations, functions, and method steps disclosed herein responsive to user inputs into the system 200 via the user interface 216, responsive to user inputs into the system from other software or external information systems communicating with the system 200 via API, and to cause outputs or storage of information or data in the database 204, the plurality of remote electronic devices 214, the node 218, and the blockchain network or system 220.

At step 2002, the exemplary system 200 is configured to establish a geospatial database of property. Further, at step 2002, the exemplary system 200 is configured to facilitate the matching of buyers and sellers for a transaction. In some exemplary arrangements, the exemplary transaction comprises a time limited exchange of access to and usage of seller owned real estate, as well as access to and storage of buyer owned property. That is, the transaction may comprise a buyer's purchase or rental of the seller's real estate in which the buyer is enabled to store buyer owned property at the seller's real estate. Further, the buyer is granted access rights to access the buyer's property stored at the seller's real estate.

The exemplary geospatial database includes information about parcels that are available for use or rent from real estate owners. The exemplary geospatial database includes information and data corresponding to real estate size, location, and details relating to accessing the property. The exemplary database further includes information relating to any building or structure located on the parcel, the storage conditions of the parcel or buildings or structures, the weather conditions, as well as any other information that a buyer may find useful in determining whether or not to store the buyer's property or goods at the seller's parcel. Of course, this arrangement is merely exemplary, and in other embodiments, other arrangements may be used.

At step 2004, the exemplary system 200 is configured to enable buyers and sellers of fractionalized real estate space to input into the system 200 their respective subjective parameters regarding the fractionalized real estate for purchase or rent. In other words, buyers and sellers are enabled to input into the system 200 the buyer's or seller's intent, such as a seller's intent to sell or rent a parcel of fractionalized real estate or a buyer's intent to rent or buy a parcel. Further, the buyers and sellers may register on the website the respective buyer's or seller's desired transaction or agreement terms.

For example, a seller may input into the system 200 subjective information relating to the seller's parcel such as restrictions on what the parcel maybe used for or used to store, access restrictions, or other restrictions or rules relating to the parcel. Similarly, a buyer may input into the system 200 subjective information such as the buyer's intended use of the property, storage needs such as parcel conditions like the need for refrigerated space or ammunitions safe space, access needs, as well as any other buyer related needs for a parcel. The exemplary system 200 is configured to receive this information from the buyers and sellers via the software 212 and to cause data corresponding to the information to be stored in the data store 204.

Further, the exemplary system 200 enables the buyers and sellers to input into the system 200 desired transaction agreement terms. That is, the buyer and seller are enabled to input desired terms for a contractual agreement between the buyer and seller for the parcel transaction. For example, the buyer and seller may input information relating to the time frame or period of use of the parcel, access requirements, a need date, as well as any other terms. The exemplary system 200 is configured to receive this information from the buyers and sellers and to cause data corresponding to the information to be stored in the data store 204.

At step 2006, the exemplary system 200 is configured to collect and store personal information relating to the buyers and sellers. The exemplary personal information includes corporate registrations of the buyers or sellers, the names of the buyer and seller, email, addresses, social security numbers, and employer identification numbers, as well as other information necessary to satisfy the government standards of real estate contracts or other contracts. In alternative exemplary arrangements, the exemplary system 100 may be in operative connection or communication with at least one external oracle or informational system such as a server external to the system 200 to obtain the necessary personal information. Such external servers may include websites, government agency databases or websites, as well as any other informational resources or databases.

The exemplary system 200 is configured to collect and store in the data store 204 data corresponding to payment related information such as bank accounts numbers and routing numbers. In alternative exemplary arrangements, the exemplary system 200 may include or be in operative connection with financial institution linking software such as Plaid® to obtain and facilitate financial related operations and functions of the system 200. However, this arrangement is merely exemplary, and in other embodiments, other arrangements may be used.

At step 2008, the exemplary system 200 is configured to collect and store in the data store 204 information or data relating to the intent of the buyers or sellers. In other words, the exemplary system 200 is configured to collect and store information relating to the buyer's desired parcel for rent or purchase. That is, the exemplary system 200 is configured to enable the users to input into the system 200 via the user interface and their respective remote electronic devices 214 personal preferences relating to the desired parcel or property for rent or purchase. This information or data includes, but is not limited to, the type of items to be stored, weight, size dimensions, hazardous or nonhazardous goods or materials to be stored, perishable or nonperishable goods or materials to be stored, desired price ranges, as well as desired locations. Of course, this arrangement is merely exemplary, and in other embodiments, other arrangement may be used.

At step 2010, the exemplary system 200 is configured to facilitate communication between a seller and a buyer to enable the buyer and seller to reach an agreement based on the buyer's and seller's intent. That is, the exemplary system 200 is configured to enable the buyer and seller to communicate through messaging, voice chat, or video chat. The exemplary system may further include security measures to maintain the confidentiality of the communications as well as to protect any proprietary information disclosed during the communication. For example, the exemplary system 200 is configured to facilitate and protect the confidentiality of communication for the buyer and the seller to negotiate the terms of an agreement for purchase or sale of fractionalized real estate space.

At step 2012, the exemplary system 200 is configured to generate and store in the data store 204 or on blockchain network 222, a smart contract according to the negotiated terms of the agreement for rent or purchase of a parcel of fractionalized real estate space. That is, the system 200 is configured to generate and execute a smart contract including all of the terms of the transaction for purchase or rent of the parcel of fractionalized real estate.

At step 2014, the exemplary system 200 is configured to facilitate payment terms between the buyer and seller to ensure performance of the agreement terms by the seller and buyer. That is, the exemplary system 200 is configured to facilitate and cause or carry out the transfer of payment between the parties as agreed upon in the agreement. Payments may be on a one time or recurring basis between the seller and buyer.

At step 2016, the exemplary system 200 is configured to facilitate communication between a seller and a buyer's agents, authorized associates, or representatives who seek or need access to the seller's parcel. In such arrangements, the exemplary system 200 is configured to enable a buyer to grant permission or authorization through inputs to the system 200 to other individuals or entities for entrance and access to a buyer's purchased or rented parcel of fractionalized real estate.

At step 2018, the exemplary system 200 is configured to facilitate the communication of data and information related to a buyer obtaining physical access to and usage of the seller's parcel. In exemplary arrangements, the exemplary system 100 is configured to communicate to the buyer the access information and data upon the seller's acceptance of the agreement.

The exemplary method 2000 may further include a step 2020. At step 2020, the exemplary system 200 is configured to provide pre-sale risk mitigation by allowing a real estate owner or their affiliates to commit digital assets, such as a cryptocurrency, as a guarantee of safety for the buyer's property that is being stored in or on a seller's piece of real estate. For example, the buyer agrees to an insurance value such as a value equal to the buyer's property being stored at the seller's parcel, and the smart contract is configured to establish an escrow account in which the digital currency equaling the value is transferred from the seller and/or its affiliates upon execution of the contract. The seller and/or its affiliates are provided some value for providing the digital currency as risk mitigation insurance. Thereafter, if the buyer's property was to sustain any damage or be lost, the smart contract automatically transfers the insurance value to a buyer associated financial account. Of course, this arrangement is merely exemplary, and in other embodiments, other arrangements may be used.

The exemplary method 2000 may further include a step 2022. At step 2022, the exemplary system 200 is further configured to enable access to the seller's parcel, by generating and delivering or communicating to the buyer, digital keys, cryptographic key stores, and alphanumeric access codes that are designed to enable the buyer to access the premises for storing, or retrieving buyer owned property stored at the seller's parcel.

The exemplary method 2000 may further include a step 2024. At step 2024, the exemplary system 200 is further configured to provide digital surveillance at the seller's parcel, thereby enabling the buyer to monitor their property that is stored at the seller's parcel. In exemplary arrangements, a buyer is enabled to view surveillance data, records, or streams via the user interface and the remote electronic device 114, thereby enabling the buyer to determine the status and security of the buyers property stored at the seller's parcel.

At step 2020, the exemplary system 200 is configured to facilitate the communication of data and information to authorized platform users and government agencies regarding details of the transactions between sellers and buyers. In exemplary arrangements, the exemplary system 200 is configured to prepare a court order related to the details of a fractionalized real estate transaction between a buyer and seller, as well as details related to the contents of the buyer owned property residing on a seller owned parcel of fractionalized real estate.

In alternative exemplary arrangements, the exemplary system 200 is configured to enable real estate agents or brokers to register in the system 200 and represent the buyer or seller in a transaction. However, the exemplary arrangements are not limited hereto.

An alternative exemplary arrangement comprises a computer implemented method of purchasing and commercializing real estate that includes establishing a geospatial database of a plurality of fractionalized real estate properties. The exemplary arrangements may further include enabling a buyer and a seller to input into another database, data corresponding to the buyer's and seller's desired parameters relating to a portion of a fractionalized real estate property. The exemplary arrangements may further include automatically obtaining and storing data corresponding to information relating to the buyer and seller. The exemplary arrangements may further include matching a buyer and a seller for a transaction relating to a portion of a fractionalized real estate property. The exemplary arrangement may further include facilitating communication between the buyer and seller for negotiation of an agreement relating to the portion of the fractionalized real estate property. The exemplary arrangements may further include enabling third party payment entities to complete payment according to the agreement. The exemplary arrangements may further include enabling the buyer and seller to communicate regarding the buyer's access to the portion of the fractionalized real estate property.

In alternative exemplary arrangements, the agreement comprises a smart contract formed between the buyer and seller. In alternative exemplary arrangements, the agreement comprises a smart contract formed between the buyer and seller. The exemplary smart contract is stored on a blockchain database.

In alternative exemplary arrangements, the method may further include minting a non-fungible token corresponding to the portion of the fractionalized real estate property. The exemplary non-fungible token is stored on a blockchain database.

In alternative exemplary arrangements, the method may further include establishing a decentralized autonomous organization. The exemplary decentralized autonomous organization is configured to manage the portion of the fractionalized real estate property.

In alternative exemplary arrangements, the buyer is enabled to store the buyer's property at the portion of the fractionalized real estate property.

In alternative exemplary arrangements, the method may further include enabling risk mitigation for the portion of the fractionalized real estate property. The exemplary risk mitigation comprises committing digital assets as collateral to guarantee the safety of items at the portion of the fractionalized real estate property.

In alternative exemplary arrangements, the agreement comprises a smart contract formed between the buyer and seller. The exemplary smart contract is stored on a blockchain database, and the smart contract includes terms relating to the fractionalized real estate property.

In alternative exemplary arrangements, the method may further include minting a plurality of non-fungible tokens. Each non-fungible token corresponds to a respective portion of a fractionalized real estate property and includes terms relating to usage of the respective portion of the fractionalized real estate property. The exemplary agreement comprises a smart contract formed between the buyer and seller, and the smart contract is stored on a blockchain database, and wherein each of the non-fungible tokens is associated with the smart contract for the fractionalized real estate property.

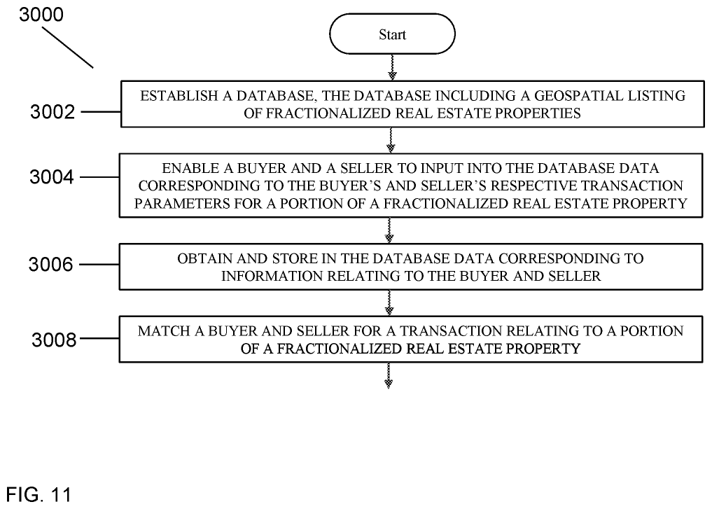

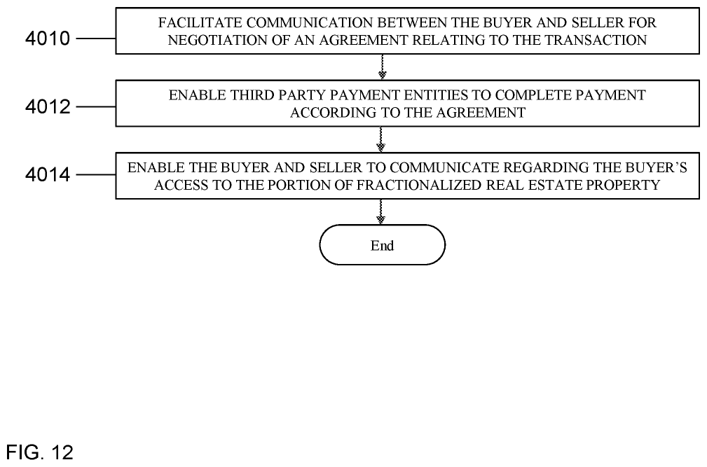

In an alternative exemplary method 3000 comprising a system 300, the exemplary method comprises the steps as shown in FIGS. 11 and 12. System 300 is identical to the systems 10 and 200 and includes all of the features and relationships and methods in association therewith. As shown therein, at step 3002 the exemplary system is configured to establish a database, the database includes a geospatial listing of fractionalized real estate properties. At step 3004 the exemplary system 300 is configured to enable a buyer and a seller to input into the database data corresponding to the buyer's and seller's respective transaction parameters for a portion of a fractionalized real estate property. At step 3006, the exemplary system 300 is configured to automatically obtain and store in the database data corresponding to information relating to the buyer and seller. At step 3008, the exemplary system 300 is configured to match a buyer and seller for a transaction relating to a portion of a fractionalized real estate property. At step 3010, the exemplary system is configured to facilitate communication between the buyer and seller for negotiation of an agreement relating to the transaction. At step 3012, the exemplary system 300 is configured to enable third party payment entities to complete payment according to the agreement. At step 3014, the exemplary system 300 is configured to enable the buyer and seller to communicate regarding the buyer's access to the portion of fractionalized real estate property. However, as can be appreciated, this arrangement is merely exemplary, and in other embodiments, other arrangements may be used.

An alternative exemplary arrangement comprises a computer implemented method of purchasing and commercializing real estate, including: establishing a database, wherein the database includes data corresponding to a plurality of fractionalized real estate properties; receiving and storing in the database transaction data corresponding to a buyer and a seller, wherein the transaction data includes information relating to respective buyer transaction parameters for a transaction relating to a portion of a fractionalized real estate property; matching a buyer and a seller based on the respective transaction data of the buyer and seller; and facilitating communication between the buyer and seller for negotiation of an agreement relating to the transaction. Of course, this arrangement is merely exemplary, and in other embodiments, other arrangements may be used.

An alternative exemplary arrangement comprises a computer implemented method of purchasing and commercializing real estate, comprising: establishing a database, wherein the database includes data corresponding to a plurality of fractionalized real estate properties; enabling a buyer and a seller to input into the database data corresponding to the buyer's and seller's respective transaction parameters for a transaction relating to a portion of a fractionalized real estate property; receiving and storing data corresponding to transaction information relating to the buyer and seller; matching a buyer and a seller for a transaction relating to a portion of a fractionalized real estate property; facilitating communication between the buyer and seller for negotiation of an agreement relating to the transaction; enabling third party payment entities to complete payment according to the agreement; and enabling the buyer and seller to communicate regarding the buyer's access to the portion of the fractionalized real estate property. Of course, this arrangement is merely exemplary, and in other embodiments, other arrangements may be used.

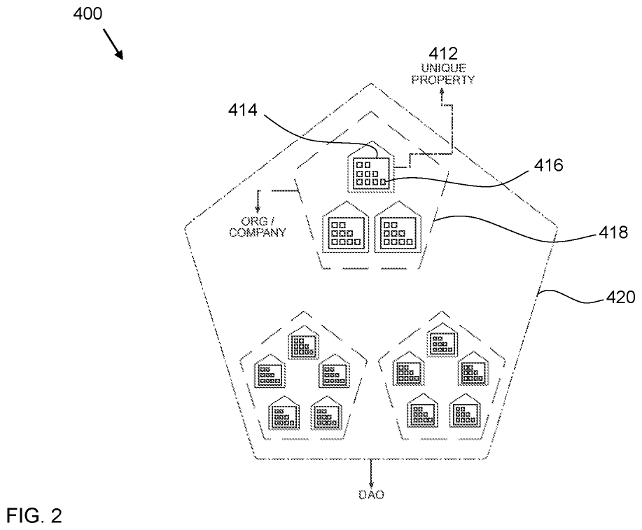

An alternative exemplary embodiment is shown in FIG. 2 comprising an alternative system for purchasing and commercializing real estate system 400. The exemplary system 400 is identical to the other systems described herein, includes all the features and relationships of the other arrangements and embodiments disclosed herein, and includes the additional features and relationships as discussed below. In addition, features and relationships with similar terminology are identical to and include all the features and relationships of the previously discussed, similarly termed features and relationships previously discussed herein.

FIG. 2 shows an overall structure of a DAO in relationship to property owners (which may alternatively be referred to herein as sellers). FIG. 2 shows unique parcel of property 412, which would typically be registered at a government recording or public records database showing ownership of real property. The exemplary property 412 may comprise a piece of land with no building or improvements on it, or it could be a building such as a house or office space.

In alternative exemplary arrangements, the property 412 may be divided into parcels of land and/or buildings or structures placed on the land. For example, if there is a shed, a garage, and a house, each structure may be its own unit that is transferable between a buyer and seller through the system. And further examples, and office building, a warehouse, or multiple warehouses may be present on a parcel of property for 12. The building and warehouses also represent units that may be transferable between a buyer and seller through the system 400. Further, the system 400 may generate and NFT and a smart contract for each of these transferable units, identical to the NFTs previously discussed herein.

The exemplary system 400 further includes a unique room or individual storefront within a home or office space 414. The exemplary unique room or individual storefront for 14 could be a walled off area where there are multiple spaces 414 within a building.

The exemplary system 400 further includes a unique fractional area of storage 416, such as a 10 by 10 trade show booth within a convention center, or a section of warehouse. The warehouse may be further divided with racks and shelving systems. The information corresponding to the unique fractional area of storage may include a unique area for storing pallets, such as in an automated warehouse facility where a robot would know where to automatically move the pallet and store it temporarily.

The exemplary system 400 further includes a unique organization, natural person, or entity 418 who owns the parcel or set of parcels or transferable units 414 or 416. In exemplary arrangements of the organization 418, the organization for 18 may comprise multiple companies, property owners, or other entities within a DAO 420. DAO 420 is identical to the DAOs previously discussed herein.

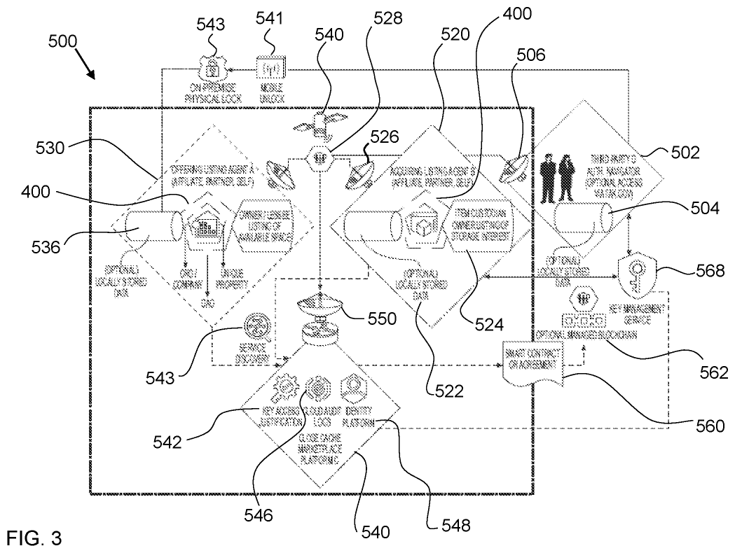

An alternative exemplary embodiment is shown in FIG. 3 comprising an alternative system for purchasing and commercializing real estate system 500. The exemplary system 500 is identical to the other systems described herein, includes all the features and relationships of the other arrangements and embodiments disclosed herein, and includes the additional features and relationships as discussed below. In addition, features and relationships with similar terminology are identical to and include all the features and relationships of the previously discussed, similarly termed features and relationships previously discussed herein.

As shown in FIG. 3, the exemplary system 500 includes a DAO 500 that is indicative of rules relating to the unique seller parcels of real estate or unique buyer property under management and/or administration under the usage of the system.

The exemplary system 500 includes a telecommunication network the is configured to enable data connection via a mobile device to unlock the property under usage by the buyer or the buyer's authorized third-party agents to access the buyer's property located on the seller's owned or leased real estate.

The exemplary system 500 includes an authorized third-party navigator 502 who is permitted to access the seller's property on behalf of the buyer. This person 502 should have access instructions and/or digital access keys to permit them to gain entry, and it would also be specified in regards to the times person 502 is allowed to access the property to store, access, or retrieve buyer owned property or other property authorized for usage, such as if their access permits them to utilize a portion of DAO-owned resources, such as ammunition that the DAO owns on a shooting range utilized by the buyer's third party agent(s), which then depletes an account related to the buyer. In exemplary arrangements, there may be a portion of replenishable assets that are DAO-owned until they are accessed, in which case the portion associated with an NFT owned by the buyer would be depleted against that account even if an authorized third-party agent is utilizing these assets and it is not directly the buyer themselves utilizing the assets.

The exemplary system 500 further includes access data 504 related (also related to 236 for access) to the ability to access the property. The exemplary data 504 does not have to be directly connected to the system in the cloud or telecommunications network, but is indicative of data that either the system provides on behalf of the buyer to a buyer's third party agent, or the buyer directly provides to the third party agent to allow them access to the property, such as if the buyer has a unique encrypted lock application that would directly transfer the key code or access credentials to this third party agent without the knowledge of the system or any record of it stored, for privacy reasons. This local data storage can also store information about other pieces of relevant information, such as when a key was given to the third-party agent by the buyer (including data corresponding to a time, a date, and a person, individual or entity, and other information relevant to authenticating the user who has permission to access the property and when they are allowed to access it.

The exemplary system 500 further includes an optional local data store 536 for key access to the property (related to 204 for access), which can permit a buyer or buyer's third-party agent to access the property without any internet connection required to gain entry. This is considered the other half of a key pair to unlock a digital lock. This local data storage can also pertain to who is allowed to access the property, at what times access may be granted, and how to authenticate the buyer or their authorized representative to ensure that the person accessing the facility also matches the intent of the contract established between buyer and seller.

The exemplary system 500 further includes a data connection 506. For example, the exemplary data connection 506 comprises internet, a 5G or other telecommunication network, a satellite connection, or other radio or data connected means to connect the buyer's third-party authorized agent to the buyer and/or system to obtain contract details. The exemplary contract details include what is contained in or on the seller's leased property and/or access information needed to access the property. In alternative exemplary arrangements, this can also be related to geographical visualization of the property within a connected system, such as TAK.gov or another geospatial command and control application. In alternative exemplary arrangements, the exemplary system may be integrated through API with TAK.gov to enable property information to be visualized within a mapping application or software.

The exemplary system 500 further includes a buyer 520. Alternatively, 520 may comprise a listing agent of the property. For example, the listing agent is owed a sales commission, typically 3%, for listing the interest in storing buyer-owned property on behalf of the buyer. However, this listing agent could also be the buyer themselves if they are listing their intent to store buyer-owned items and/or property using the system.

The exemplary system 500 further includes data 522 corresponding to the buyer's interests. This locally stored data 522 may include, but is not limited to, information that the system or other third-parties are not privy to, such as if a buyer did not want to disclose the contents of their buyer-owned or buyer-stored property to the seller or to the system, and only wanted to share this data with buyer's third party agents who would be permitted to know the contents and gain access to the property. The buyer would be able to decide who they want to share this information with before it is sent to other involved parties. They could also choose to disclose this information to the seller but not the system. In some cases, the buyer may wish to store keys for access-controlled boxes being stored on the seller's property (such as a locked Pelican® case) that may have a digital access key or keycode that the buyer only wishes to share with a buyer's authorized third party agent. The system could optionally be involved to store the key in an encrypted form and release it only to the buyer's third party authorized agent(s), such that the system may hold the data but not know the contents (access keys) of the data because the buyer's third party agent would be the only person authorized to use their digital key to retrieve this information, which then grants them the access key for the unique box they would like access to.

In alternative exemplary arrangements, there could be multiple digital keys involved. For example, in an exemplary scenario, a buyer sends a digital encrypted keystore related to identity (more of an indication digitally that this party is authorized to act on behalf of the buyer) to an authorized third-party agent of the buyer, which then gives them the ability to request future access keys from the system. Alternatively, a seller could store an access key on the system. The third party agent would then be able to request multiple digital keys at the time of entry, or before the time of entry (such as they are traveling to a foreign country and plan to not have internet access), which then sends their digital identity-related keystore to the system which grants them download of separate digital access keys needed to physically access the seller's property and to physically access the buyer's secured box. The system would then log the time of request, by whom it was requested, and to which mobile device (unique device identifier) the digital keys were sent to.

The exemplary system 500 further includes another buyer 524, The buyer 524 wishes to serve as custodian of an item or group of items (buyer owned property) that will be placed on a future seller's property under which the buyer is leasing and/or buying through our system (i.e., buying an NFT where a fraction of the property is purchased for a defined period of time, which may be recurring, such as yearly or daily or hourly, like in a tradeshow booth or a hotel or a startup incubator for day-use of desk space).

The exemplary system 500 further includes a data connection 526. For example, the data connection 526 comprises an internet connection, a 5G or other telecommunication network, a satellite connection, or any other radio or data connection means to connect the buyer to the seller and/or system and/or third party authorized agent(s) to negotiate and settle contract details. For example, the contract details include what buyer-owned property is contained in or on the seller's leased property and/or helps to negotiate and retrieve data and/or credentials needed to access the property. In alternative exemplary arrangements, this data can also be related to geographical visualization of the property within a connected system, such as TAK.gov or another geospatial command and control application. In still other alternative exemplary arrangements, the exemplary system 500 is configured to integrate its data with TAK.gov through API or an alternative plugin means so property information may be visualized within a mapping application or software. In such arrangements, the buyer is enabled to access the system on either their electronic device or mobile device software application or on a web browser. Further, exemplary buyer or seller may wish to utilize the system via APIs to retrieve and store information related to their intent to buy and/or lease property from a seller.

The exemplary system 500 further includes a hub 528 that is configured to connect the buyer, seller, and system as part of a cloud internet network. That is, the hub 528 links the various devices between servers associated with or in operative connection with the system and devices or computers used by the seller and buyer and their respective authorized agents or listing agents (realtors).

The exemplary system 500 further includes a seller 530. In alternative exemplary arrangements, the exemplary seller 530 may comprise a listing agent. For example, listing agent 530 is owed a sales commission, typically 3%, for listing the intent to sell or lease property associated with the seller. The exemplary listing agent 530 may also comprise the seller themselves if they are listing their intent to sell and/or lease property on the system.

The exemplary system 500 further includes a data connection 532. The exemplary data connection 532 is identical to the data connections 506 and 526.

The exemplary system 500 further includes a seller 534. The exemplary seller 534 comprises a custodian, owner, or lessee of a piece of real property as indicated at a court house or other records office kept by a jurisdiction, such as a county in the United States, or in other countries.

The exemplary system 500 further includes a connected device 538 such as a satellite or internet data provider connected to the internet which routes the seller and buyer to the system, or to one another for direct exchange of information such as with private access keys that are not known by the system.

The exemplary system 500 further includes a means 540 such as a software code, an external system, or other computer that is configured to broker exchanges between buyer and seller.

The exemplary system 500 further includes a mobile trigger 541 or radio capability, such as RFID or other key card means like Bluetooth or Wi-Fi, that are necessary to connect with a digital lock and authorized access for the buyer or buyer's third-party agent to the property. In alternative exemplary embodiments, not shown in FIG. 3, the exemplary trigger 541 may be in operative connection with a digital lock that a buyer must use to access the buyer's property stored at the seller's real estate.

The exemplary system 500 further includes a subsystem 542. Subsystem 542 is configured to evaluate who is authorized to access the property on behalf of the buyer and at what times, as permitted by the seller and negotiated by both parties as part of the final smart contract.

The exemplary system 500 further includes a physical locking device 543 that intakes a key from the buyer or buyer's third party authorized agent to unlock the seller's property and permit access. There may be multiple of these locks with different alternating key codes across different authorized users.

The exemplary system 500 further includes a means of logging 546. The exemplary means 546 comprises a sub-data store that is configured to store who is permitted to access the property and make contract modifications. This logging may also pertain to consumable items related to the DAO, such as who may be permitted to use resources, such as ammunition, food, energy, or other consumables. This logging may also be related to billing the buyer for excessive consumption beyond a set limit.

The exemplary system 500 further includes an identity management system 548 that is configured to comply with government standards related to who owns the property, who rents, who buys the property, who is permitted to access the property, and what is stored on the property, as well as who is authorized to access consumables owned under the DAO until they are transferred for use to the buyer or buyer authorized third party agent(s).

The exemplary system 500 further includes a data center connection 550 of the system servers to the network that connects the buyer and seller.

The exemplary system 500 further includes smart contract 560 or other agreement that is digitally kept as a record of what the seller and buyer both agree to do as part of the transaction

The exemplary system 500 further includes an optional data store 560. The exemplary optional data store 560 is configured to store data corresponding to, but not limited, a smart contract, NFT, and/or DAO on a managed blockchain. The exemplary data store 50 could be a private blockchain stored on a server network from a provider like AWS, Azure, or Google Cloud, or it could be on a public blockchain network like Ethereum or Cardano.

The exemplary system 500 further includes an optional data store 268. The optional data store 268 is identical to the data store 560 and is configured to store data corresponding to, but not limited to, keys related to identity and access control, and a processor in operative connection with the data store 560 is configured to permit disclosure of the data stored therein based on parameters set by the seller and/or buyer related to being able to access buyer-owned or seller-owned property.

Although a few exemplary arrangements and embodiments of the present general inventive concept have been illustrated and described, it will be appreciated by those skilled in the art that changes may be made in these exemplary arrangements and embodiments, and combinations of the various features and relationships and method steps of these exemplary arrangements and embodiments may be made, without departing from the principles and spirit of the general inventive concept, the scope of which is defined in the appended claims and their equivalents.

What is claimed is:

1. A computer implemented method of purchasing and commercializing real estate, comprising:
establishing a geospatial database of a plurality fractionalized real estate properties;
enabling a buyer and a seller to input into a further database data corresponding to the buyer's and seller's desired parameters relating to a portion of a fractionalized real estate property;
automatically obtaining and storing data corresponding to information relating to the buyer and seller;
matching a buyer and a seller for a transaction relating to a portion of a fractionalized real estate property;
facilitating communication between the buyer and seller for negotiation of an agreement relating to the portion of the fractionalized real estate property;
enabling third party payment entities to complete payment according to the agreement; and
enabling the buyer and seller to communicate regarding the buyer's access to the portion of the fractionalized real estate property.

2. The method according to claim 1, wherein the agreement comprises a smart contract formed between the buyer and seller.

3. The method according to claim 1, wherein the agreement comprises a smart contract formed between the buyer and seller, wherein the smart contract is stored on a blockchain database.

4. The method according to claim 1, further comprising:
minting a non-fungible token corresponding to the portion of the fractionalized real estate property, wherein the non-fungible token is stored on a blockchain database.

5. The method according to claim 1, further comprising:
establishing a decentralized autonomous organization, wherein the decentralized autonomous organization is configured to manage the portion of the fractionalized real estate property.

6. The method according to claim 1, wherein the buyer is enabled to store the buyer's property at the portion of the fractionalized real estate property.

7. The method according to claim 1, further comprising:
enabling risk mitigation for the portion of the fractionalized real estate property, wherein the risk mitigation comprises committing digital assets as collateral to guarantee the safety of items at the portion of the fractionalized real estate property.

8. The method according to claim 1, wherein the agreement comprises a smart contract formed between the buyer and seller, wherein the smart contract is stored on a blockchain database, wherein the smart contract includes terms relating to the fractionalized real estate property.

9. The method according to claim 1, further comprising:
minting a plurality of non-fungible tokens, wherein each non-fungible token corresponds to a respective portion of a fractionalized real estate property, and wherein each non-fungible token includes terms relating to usage of the respective portion of the fractionalized real estate property, and
wherein the agreement comprises a smart contract formed between the buyer and seller, wherein the smart contract is stored on a blockchain database, and
wherein each of the non-fungible tokens is associated with the smart contract for the fractionalized real estate property.

10. A computer implemented method of purchasing and commercializing real estate, comprising:
establishing a database, wherein the database includes data corresponding to a plurality of fractionalized real estate properties;
enabling a buyer and a seller to input into the database data corresponding to the buyer's and seller's respective transaction parameters for a transaction relating to a portion of a fractionalized real estate property;
receiving and storing data corresponding to transaction information relating to the buyer and seller;
matching a buyer and a seller for a transaction relating to a portion of a fractionalized real estate property;
facilitating communication between the buyer and seller for negotiation of an agreement relating to the transaction;
enabling third party payment entities to complete payment according to the agreement; and
enabling the buyer and seller to communicate regarding the buyer's access to the portion of the fractionalized real estate property.

11. The method according to claim 10, wherein the agreement comprises a smart contract formed between the buyer and seller.

12. The method according to claim 10, wherein the agreement comprises a smart contract formed between the buyer and seller, wherein the smart contract is stored on a blockchain database.

13. The method according to claim 10, further comprising:
minting a non-fungible token corresponding to the portion of the fractionalized real estate property, wherein the non-fungible token is stored on a blockchain database.

14. The method according to claim 10, further comprising:
establishing a decentralized autonomous organization, wherein the decentralized autonomous organization is organized on a blockchain database and is configured to manage the fractionalized real estate property.

15. The method according to claim 10, further comprising:
enabling risk mitigation for the portion of the fractionalized real estate property, wherein the risk mitigation comprises committing digital assets as collateral to guarantee the safety of items at the portion of the fractionalized real estate property.

16. The method according to claim 10, wherein the agreement comprises a smart contract formed between the buyer and seller, wherein the smart contract is stored on a blockchain database, wherein the smart contract includes terms relating to the fractionalized real estate property.

17. The method according to claim 10,
minting a plurality of non-fungible tokens, wherein each non-fungible token corresponds to a respective portion of a fractionalized real estate property, and wherein each non-fungible token includes terms relating to usage of the respective portion of fractionalized real estate property, and
wherein the agreement comprises a smart contract formed between the buyer and seller, wherein the smart contract is stored on a blockchain database, and
wherein each of the non-fungible tokens is associated with the smart contract for the fractionalized real estate property.

18. A computer implemented method of purchasing and commercializing real estate, comprising:
establishing a database, wherein the database includes data corresponding to a plurality of fractionalized real estate properties;
receiving and storing in the database transaction data corresponding to a buyer and a seller, wherein the transaction data includes information relating to respective buy and seller transaction parameters for a transaction relating to a portion of a fractionalized real estate property;
matching a buyer and a seller based on the respective transaction data of the buyer and seller; and
facilitating communication between the buyer and seller for negotiation of an agreement relating to the transaction.

19. The method according to claim 18, further comprising:
minting a plurality of non-fungible tokens, wherein each non-fungible token corresponds to a portion of a fractionalized real estate property, and wherein each non-fungible token includes terms relating to usage of the portion of fractionalized real estate property, and
wherein the agreement comprises a smart contract formed between the buyer and seller, wherein the smart contract is stored on a blockchain database, and
wherein each of the non-fungible tokens is associated with the smart contract for the fractionalized real estate property.

20. The method according to claim 19, further comprising:
establishing a decentralized autonomous organization, wherein the decentralized autonomous organization is organized on the blockchain database and is configured to manage the fractionalized real estate property.
